(19) United States
(12) Patent Application Publication
(10) Pub. No.: US 2010/0019492 A1
(43) Pub. Date: Jan. 28, 2010

(54) Tube Connector for Intake Manifold

(76) Inventor: Timothy J. Richards, Santee, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/509,358

(22) Filed: Jul. 24, 2009

Related U.S. Application Data
(60) Provisional application No. 61/083,459, filed on Jul. 24, 2008.

(51) Int. Cl. F16L 17/00

(52) U.S. Cl. 285/346

(57) ABSTRACT

An air intake conduit connecter having two components engaged by an annular ring engaging one component and biasing towards the engagement. A resilient band is engageable around the annular ring to allow hand tightening thereof and preventing vibration from loosening the threaded engagement of the ring.

### FIELD OF THE INVENTION

The disclosed device relates to connections for fluid conduits. More particularly it relates to a conduit connection for an intake manifold for an internal combustion engine which allows for the quick engagement and disengagement of the connection while concurrently providing a sealed communication between the two adjoining component conduits. In addition to a frictional engagement of components by a threaded collar, an elastic safety band wider than the collar, provides a means to prevent the connection from loosening due to engine vibration.

### BACKGROUND OF THE INVENTION

Modern internal combustion engines must have a regulated supply of air to mix with a measured amount of fuel being provided for combustion in the cylinders. A conventional design for delivering air for mixture with the fuel employs a throttle body which is opened and closed to allow varied amounts of air for mixture with fuel communicated to the engine combustion system. On a fuel-injected engine, the fuel supply communicated to the combustion system through injectors or the throttle body, must be continually and carefully regulated according to the amount of air being input.

Because, on average, the air ingested by an engine is at least fourteen times the volume of fuel consumed, internal combustion engines need a large volume of clean air to mix with the metered fuel. The air must be clean to avoid dust and particulate from damaging the engine and to prevent a build up of such inside the cylinders and air conduits of the engine over time.

As such, an air cleaner is generally the first component incoming air encounters in its travel into the engine. Once past the air cleaner, the air measured for volume and then directed into a conduit which is engaged at an opposite end from the air cleaner, with the intake of the engine such as the throttle valve and then onto the cylinders.

Conventionally, a hose clamp or other user-tightened clamp is employed to engage a flexible hose or conduit between an incoming air conduit and the throttle valve intake. The use of a clamp and hose engagement is generally unsightly, creates a need for a hose clamp removal tool, and is subject to leaks as it ages. Further conventional flexible conduits create turbulence inside the conduit from the uneven surfaces of the inside surfaces of the hose and the aluminum, metal, or plastic conduits providing the measured clean air supply to the throttle valve intake. It is well known that such air turbulence caused by the uneven surfaces inhibits the efficiency of the engine.

Screw on or threadably engaged components have been employed in the past to engage the intake conduit from the air cleaner in a sealed engagement to the throttle body or similar component. However, such devices are expensive and fail to form a smooth interior wall of the joined components. The uneven formed air path thereby still imparts significant air turbulence to the fluid flow. Further, such are known to suffer from a loosening of the threadably engaged components caused by engine vibration communicated through the solid component parts from the engine. This loosening effect can occur rapidly unless secured with an unsightly clamp or other locking device to prevent the loosening over time of the connection threaded connections.

One effort to cure this loosening affliction has been to employ self-locking threads, such as using pipe threading, for the threaded components. Frictional engagement from a torqued nut holds the components engaged in place. However, detachment is inhibited in that it requires one or two wrenches to disengage the components and provides for a slow removal.

The importance of a sealed connection of air flow conduits cannot be over emphasized in modern computer controlled engines. Air leaking into the conduits after a volume has been measured and communicated to a fuel calculating component will cause a mismatch of the calculated fuel and air ratio fed to the engine. Such leaking can cause an unsafe or inefficient air to fuel ratio since the connection of the conduit components is generally located past the air flow sensor delivering air intake volume to the engine's computer which employs such to regulate fuel flow to match air intake volume. Any such extra air communicated into the system at the point of the connection, if past the air volume measurement point, will generally cause a lean mixture in the engine. Lean mixtures are known to cause pre-ignition which, unchecked, can damage the engine.

In racing applications, where entire engines are replaced in a single unit, a quick disconnect for the filtered air conduit leading into the intake manifold is especially important. Racing requires the driver to traverse a course in the least amount of time possible or to execute timed segments over a duration of days in qualifying and then during a race. It is common for an entire engine to be changed or replaced as a unit and engaged to a body mounted air filtering and metering system. Consequently, quick connecting and disconnecting air supply conduit components are a must to decrease mechanic time. However, such connections must be secure, air tight, resistant of vibration, and permit little or no formation of air turbulence inside the conduits which could rob performance.

As such, for general automotive and especially racing applications, there exists an unmet need for an improved connection device for air conduits in internal combustion engines. Such a device should preferably be hand-engageable to prevent over-torque of the components using tools and the need for tools. Unlike conventional flexible tubing, such a connecting device should link adjoining conduits with a minimum of deformation of the interior wall surface to increase laminar fluid flow inside the conduit by avoiding turbulence formation. Such a device if used in racing applications, in addition to being hand tightened, should engage and disengage quickly, yet provide a stable and sealed engagement after each use to avoid leaking of the fuel mixture to the engine. In addition to being quickly hand-engageable and yielding a high quality seal and smooth operating conduit interior, such a device should be adapted to prevent the hand-engaged threaded components from coming loose over time from the effects of engine movement and vibration.

With respect to the above, before explaining at least one preferred embodiment of the connector invention in detail, it is to be understood that the invention is not limited in its application to the details of construction and to the arrangement of the components or steps set forth in the following description or illustrated in the drawings. Nor is it limited to the most preferred modes of the device described herein. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should by no means be regarded as limiting.

As such, those skilled in the art will appreciate that the conception upon which this disclosure is based may readily be utilized as a basis for designing of other non-loosening quick connector devices for fluid conduits on internal combustion engines and for carrying out the several purposes of the present disclosed device. It is important, therefore, that the objects and claims be regarded as including such equivalent construction and methodology insofar as they do not depart from the spirit and scope of the present invention.

### SUMMARY OF THE INVENTION

The disclosed device provides great utility in solving the aforementioned problems related to intake air and fluid conduit connectors for internal combustion engines such as the conduit leading from the air cleaner to the air intake for the fuel injection or similar air and fuel mixing system of the vehicle. The device is especially well adapted to racing and high performance applications where a quickly engageable connector, which is secure from vibration, yet minimizes air turbulence in the formed conduit, would be a competitive performance advantage.

The device features a first connector adapted at a first end for engagement to the air intake conduit for an internal combustion engine such as the conduit leading into the throttle body or carburetor. The first connector has threads formed on the exterior at its second end, and has a mating surface communicating between the exterior surface and an interior wall surface.

Positioned operatively upon the mating surface is a resilient “O” ring which is preferably situated in a slot formed into the mating surface. The O-ring projects just above the mating surface and is of a material adapted to maintain a resistive bias against any compression.

At the base of the formed threads, opposite the leading end of the threads at the second end of the first connecter, is a shoulder portion. The shoulder portion has a seat formed circumferentially around the exterior surface of the first component. The seat is adapted to contact a threaded ring component. The outside surface of the shoulder portion angles away from the center axis of the first component toward a peak of the shoulder to provide an increase in the surface area for engagement of a resilient band thereon which provides a means to prevent a loosening of the ring component from the first component due to the effects of engine vibration and movement over time. This angled exterior surface increases the available surface area of contact for the resilient band, and provides a smooth transition from the exterior of the ring component to avoid damage to the resilient band.

A second component is adapted to engage with the first component and held in such an engagement by the threaded engagement of the ring component. The second component has an interior surface forming a passage and an exterior surface. This interior surface forms a conduit that is substantially equal to the conduit formed by the interior surface of the first component. A shoulder is formed on the first end of the second component about its exterior surface.

A mating face communicates across a front portion of the shoulder and communicated with the interior surface of the second component. The mating face is adapted to contact and compress the resilient seal on the face of the first component and to thereby achieve a complete seal of the formed interior conduit once in such contact. A second end of the second component is adapted to engage the incoming air conduit from the air cleaner in a sealed engagement. On the opposite side of the mating face portion of the shoulder is formed a seat. This seat is adapted for a contact with an interior ridge of the ring component.

This ring component has an interior wall surface and exterior surface. At a first end of the interior surface of the ring component threads are formed which are adapted to engage with the threads formed at the second end of the first connector. These threads extend into the interior of the ring component a distance sufficient to engage with the threads on the first component and to cause the seat on the second component to contact the interior ridge on the ring component.

In use, the mating faces of the first and second component are adjoined. In a second step, the ring component is tightened onto threads of the first component to hold the two faces in contact with the resilient seal compressed against the face of the second component. Because of the seal, a hand tightening of the ring component will accomplish an excellent seal.

Once the ring component is engaged and holding the second component to the first, and hand-torqued, the ring component is thereafter maintained from loosening by a resilient band which engaged over the exterior of the ring component and one or preferably both of the exterior surfaces of the first and second components. The resilient band, such as a rubber band having a width wider than that of the ring component, is held in a biased engagement in this mounted position. So engaged, it maintains the ring component in its hand-torqued position despite engine vibration and movement and temperature changes over time.

The conduits formed by the respective interior surfaces of the first and second components, being substantially equal, and with the mating faces abutting each other and compressing the O-ring, form an extremely small seam or annular recess inside the assembled conduit formed by the mated components. This small seam with a minimal recess serves to reduce or eliminate the conventional problems of air turbulence formation caused by conventional connecters for intake systems which have uneven surfaces.

It is thus an object of this invention to provide a connector for the air flow taken into an internal combustion engine which minimizes turbulence and increases engine efficiency.

It is another object of the invention to provide such a connector which may be quickly hand-engaged without tools.

An additional object of this invention is to provide such a device that will maintain a tight seal between the components employing only a hand tightening, by the inclusion of an elastic band or biased band component to hold the components in a registered fixed engagement.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWINGS

FIG. 1 depicts the device showing a sliced view through the components which are aligned in an exploded view.

FIG. 2 is a view of the seal on the face of the first component and its recessed location.

FIG. 3 depicts the device in an engaged mode with ring component hand-tightened upon threads on the first connector.

FIG. 4 depicts the device as in FIG. 3, with a resilient band, wider than the ring component, surrounding the exterior surface of the ring component and contacting the exterior surfaces of adjoining components.

FIG. 5 depicts a perspective view of the interior passage formed by the engaged components and the particularly smooth wall surface formed.

### DETAILED DESCRIPTION OF THE PREFERRED EMBODIMENT

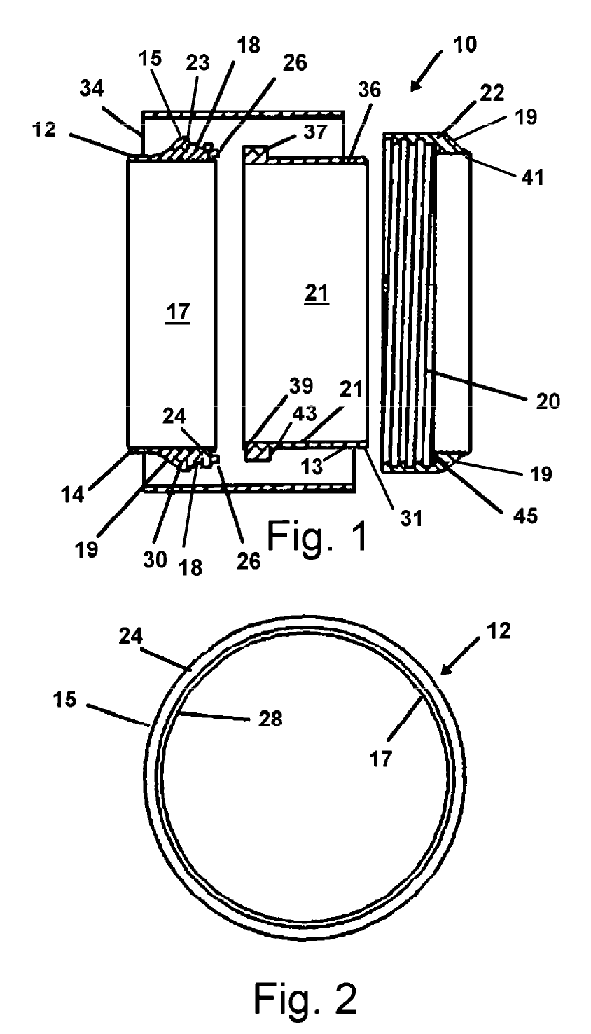

The device 10 herein is described and disclosed in FIGS. 1-5 wherein similar parts are identified by like reference numerals, which may be found in one or more of the drawings.

As depicted in FIG. 1 in a sliced view through the exploded components aligned along an axis, the device 10 features a first connector 12 adapted at a first end 14 for engagement to the air intake conduit of an internal combustion engine modernly leading to a throttle body. On the exterior surface 15 of the first connector 12 at a second end opposite the first end 14, threads 18 are formed sized to engaged mating threads 20 formed on the interior surface of the ring component 22.

A mating surface 24 communicating on a side between the exterior surface 15 and the interior surface 17 has a resilient “O” ring 26 as a sealing means engaged thereon. Means for engagement of the O-ring 26 to the mating surface 24 in the current preferred mode of the device 10 is provided by an annular slot 28 shown in FIG. 2 formed into the mating surface 24. Angled portions 19 are also preferred on the ring component 22 to match the angled portion 19 of the first component 12 and thereby provide an increased area on the exterior surface of the formed device 10 for engagement thereon of an inwardly biasing resilient band 34.

Also formed on the exterior surface 15 is a shoulder portion 30 which is positioned circumferentially around the exterior surface 15 of a mid portion of the first component 12. This shoulder portion 30 has an annular edge 23 adapted to engage with the ring component 22 as a stop. The angled portion 19 leading from the shoulder portion 30 inclines at an angle away from the exterior surface 15 in a direction toward the second end of the first component 12.

As noted both angled portions 19 provide a means to increase a surface area for engagement of a resilient band 34 thereon. This resilient band 34 when engaged to the device 10 provides a means to prevent a loosening of the ring component 22 from the threaded engagement on the first component 12 which can happen due to engine vibration. This allows the ring component 22 to be hand tightened without tools to speed up the process but eliminates the worry of loosening of the ring component 22 which would eventually cause air to get into the system which has not been metered which would cause problems with the air and fuel ration of the engine. The angled portion 19 also provides a smooth transition from the exterior of the ring component 22 onto the first component 12, as a means to avoid damage to the resilient band 34 which would occur from sharp edges and uneven surfaces if there were no such angled transition.

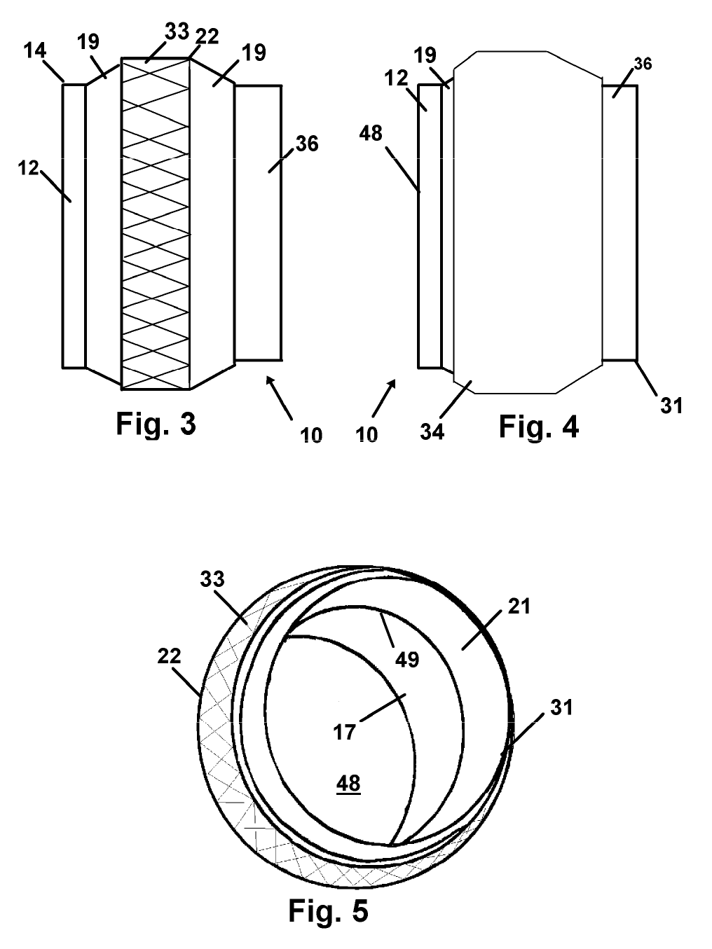

As noted the second component 36 is adapted to mate with the first component 12 in an engaged position as shown in FIG. 3 and to be held in this engaged position by the threading thereon of the ring component 22. An interior surface 21 of the second component 36 forms a passage therethrough sized substantially equal to a conduit formed by the interior surface 17 of the first component.

Mating of the first component 12 to the second component 36 is accomplished by engaging the ring component 22 threads 22 with those of the second end of the first component 12, until the ring component 36 engages upon and biases against a shoulder 37 formed on the second component 36, and biases it toward the first component 12. A gnarled surface 33 on the exterior of the ring component 22 provides a means for a user's hand to grip and turn it without slipping. A mating face 39 communicating across a front portion of the shoulder 37 is adapted to contact and compress the resilient seal or O-ring 26 on the face of the first component 12, and thereby provide a means to achieve a complete seal of the formed interior operating conduit. This operating conduit is formed by the adjacent interior surfaces 17 and 21 when the device is engaged with the ring component 22 hand-tightened upon the first component 12. An especially smooth transition between the two adjoined surfaces 17 and 21, which mated form the operating conduit 48 shown in FIG. 5. This smooth transition thereby provides a means for minimizing turbulence.

A second end 31 of the second component 36 projects through an aperture 41 communicating through the ring component 22 when it is engaged upon the first component 12 in the assembled or as-used position for the device 10 as shown in FIGS. 3-5. This second end 31 is adapted to engage the incoming air conduit from the air cleaner in a sealed engagement.

On the opposite side of the shoulder 37 of the second component 36 from the mating face 39, is positioned a seat 43. This seat 43 is adapted for a contact with an interior ridge 45 annularly disposed around the ring component 22 when it is engaged to the first component 12. Hand engagement of the ring component 22 to the first component 12 by engaging the threads 20, biases the second component 36 toward the first component 12 with a force provided by engaging the threads and the twisting the ring component 22.

As noted, engagement of the ring component 22 is provided by threads 20 a first end of the interior surface of the ring component 22 which are formed to operatively engage with the threads 18 formed at the second end of the first component 12. These threads 20 extend into the interior of the ring component 22 a distance sufficient to engage with the threads 20 on the first component 12, and to concurrently provide a correct distance for the seat 43 on the second component 36, to contact interior ridge 45 on the ring component 22.

In use, once the ring component 22 is engaged and holding the second component 36 to the first component 12 in a biased sealed engagement, the friction of the threads 20 being torqued with the hand or a tool maintains the seal. Particularly preferred due to vibration and heat causing the ring component 22 to possibly loosen over time, the ring component 22 is maintained in a tight engagement using means to maintain the position of the ring component and prevent rotation allowing a loosening thereof. Currently, the resilient band 34 which engaged over the exterior of the ring component 22 and one or preferably both of the exterior surface 15 of the first component 12 and the exterior surface 13 of the second component 36. Also preferred is the gnarled surface 33 which provides a means for engagement of the resiliant band 34 on the ring component 22 to prevent rotation thereof. The resilient band 34 is sized in its relaxed or un-stretched position to be smaller than the circumference formed by the exterior surfaces 13 and 15 of the first and second components and the ring component 22. When stretched and then relaxed in a mounted position as in FIG. 4, it is thus held in a biased engagement in this mounted position by the natural inward bias of the resilient band 34. This forms a gripping action on the first and second component and the ring component 22 surfaces, and maintains the ring component 22 in its hand-torqued position thereby providing a means to prevent rotation of the engaged ring component 22 and resulting loosening from vibration and other movement over time. The resilient band 34 is particularly important if the device 10 uses a hand-tightening of the ring component 22 to allow for quick connections and disconnections without tools. Such a hand-tightening can be inclined to loosen from vibration and temperature changes.

The conduits formed by the respective interior surfaces 17 and 21 of the first and second components, being substantially equal, provide an exceptionally smooth operating conduit 48 when the components are in the engaged position as shown in FIG. 3-5. This smooth surface is depicted in FIG. 5 and is only interrupted by an extremely small seam 49 or annular recess from the mating components. As noted, this formation of a smooth operating conduit 48 provided by the mating of the two components of the device 10 provides means to prevent or reduce turbulence in air passing through the operating conduit 48 of the assembled device 10 during use and thereby enhances engine performance.

While all of the fundamental characteristics and features of the connector herein have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. An air intake conduit connecter comprising:
a first component having a first end adapted for engagement to an air intake on an internal combustion engine, and having a second end opposite said first end;
said first component having an exterior surface defining an exterior circumference, and having an interior surface defining an axial passage there through;
a second component, said second component adapted at a first end for engagement to an air supply conduit, and having a second end opposite said first;
said second component having an exterior surface defining a first circumference of said second component;
said second component having an interior wall defining an axial pathway therethrough;
an endwall at said second end of said first component communicating between said interior surface and said exterior surface;
a face at said second end of said second component communicating between said interior wall and said exterior surface of said second component;
a shoulder extending from said exterior surface of said second component, said shoulder having a second circumference;
an annular ring component having an aperture therethrough and having threads formed upon an interior wall at a first end and having an axial passage communicating through said first end and said aperture;
said aperture sized larger than said first circumference and smaller than said second circumference;
cooperating threads on said exterior surface of said first component wherein said threads of said ring component are engageable therewith;
said second component positioned to an engaged position removably attached to said first component by an engagement of said ring component to said threads on said first component; said engagement of said ring component with said first component providing means to bias said face against said endwall in a sealed biased contact therebetween; and
a sealed conduit communicating between said first end of said first component and said first end of said second component when in said engaged position.

2. The air intake conduit connecter of claim 1 additionally comprising:
said sealed biased contact achieved by a hand-tightening of said ring component upon said threads of said first component without tools.

3. The air intake conduit connecter of claim 1 additionally comprising:
said ring having an exterior surface defining a ring circumference and defining a width extending between said first end and a second end opposite said first end;
a resilient band having an interior circumference less than said ring circumference and less than said exterior circumference and said first circumference;
said band stretchable for a positioning around said exterior surface of said ring to a biased contact therearound;
said band having a band width wider than said width of said exterior surface of said ring thereby causing an overhang portion to extend past one or both of said first end and second end of said ring;
said overhang portion contacting one or both of said first and second components in a biased engagement therewith; and
said biased contact and said biased engagement providing means to prevent said ring from turning thereby preventing a disengagement from said engaged position.

4. The air intake conduit connecter of claim 2 additionally comprising:
said ring having an exterior surface defining a ring circumference and defining a width extending between said first end and a second end opposite said first end;
a resilient band having an interior circumference less than said ring circumference and less than said exterior circumference and said first circumference;
said band stretchable for a positioning around said exterior surface of said ring to a biased contact therearound;
said band having a band width wider than said width of said exterior surface of said ring thereby causing an overhang portion to extend past one or both of said first end and second end of said ring;
said overhang portion contacting one or both of said first and second components in a biased engagement therewith; and
said biased contact and said biased engagement providing means to prevent said ring from turning thereby preventing a disengagement from said engaged position.

5. The air intake conduit connecter of claim 1 additionally comprising:
a seal extending from a seat formed in said sidewall, said seal compressible by said biased contact of said endwall therewith.

6. The air intake conduit connecter of claim 2 additionally comprising:
a seal extending from a seat formed in said sidewall, said seal compressible by said biased contact of said endwall therewith.

7. The air intake conduit connecter of claim 3 additionally comprising:
a seal extending from a seat formed in said sidewall, said seal compressible by said biased contact of said endwall therewith.

8. The air intake conduit connecter of claim 4 additionally comprising:
a seal extending from a seat formed in said sidewall, said seal compressible by said biased contact of said endwall therewith.

9. The air intake conduit connecter of claim 5 additionally comprising:
said seal being an o-ring and said seat being a groove in said sidewall adapted to engage said o-ring.

10. The air intake conduit connecter of claim 6 additionally comprising:
said seal being an o-ring and said seat being a groove in said sidewall adapted to engage said o-ring.

11. The air intake conduit connecter of claim 7 additionally comprising:
said seal being an o-ring and said seat being a groove in said sidewall adapted to engage said o-ring.

12. The air intake conduit connecter of claim 8 additionally comprising:
said seal being an o-ring and said seat being a groove in said sidewall adapted to engage said o-ring.

13. The air intake conduit connecter of claim 4 additionally comprising:
said exterior surface of said ring positioned a distance from said exterior surface of said first component and said exterior surface of said second component;
said exterior surface of said first component having an angled portion adjacent to said ring, said angled portion angling away from said first component and toward said exterior surface of said ring;
said exterior surface of said second component having an angled portion adjacent to said ring, said angled portion angling away from said exterior surface and toward said exterior surface of said ring; and
said angled portions proving an increase in contact surface area for said resilient band engaged thereon.

14. The air intake conduit connecter of claim 5 additionally comprising:
said exterior surface of said ring positioned a distance from said exterior surface of said first component and said exterior surface of said second component;
said exterior surface of said first component having an angled portion adjacent to said ring, said angled portion angling away from said first component and toward said exterior surface of said ring;
said exterior surface of said second component having an angled portion adjacent to said ring, said angled portion angling away from said exterior surface and toward said exterior surface of said ring; and
said angled portions proving an increase in contact surface area for said resilient band engaged thereon.

15. The air intake conduit connecter of claim 6 additionally comprising:
said exterior surface of said ring positioned a distance from said exterior surface of said first component and said exterior surface of said second component;
said exterior surface of said first component having an angled portion adjacent to said ring, said angled portion angling away from said first component and toward said exterior surface of said ring;
said exterior surface of said second component having an angled portion adjacent to said ring, said angled portion angling away from said exterior surface and toward said exterior surface of said ring; and
said angled portions proving an increase in contact surface area for said resilient band engaged thereon.

16. The air intake conduit connecter of claim 9 additionally comprising:
said exterior surface of said ring positioned a distance from said exterior surface of said first component and said exterior surface of said second component;
said exterior surface of said first component having an angled portion adjacent to said ring, said angled portion angling away from said first component and toward said exterior surface of said ring;
said exterior surface of said second component having an angled portion adjacent to said ring, said angled portion angling away from said exterior surface and toward said exterior surface of said ring; and
said angled portions proving an increase in contact surface area for said resilient band engaged thereon.

17. The air intake conduit connecter of claim 12 additionally comprising:
said exterior surface of said ring positioned a distance from said exterior surface of said first component and said exterior surface of said second component;
said exterior surface of said first component having an angled portion adjacent to said ring, said angled portion angling away from said first component and toward said exterior surface of said ring;
said exterior surface of said second component having an angled portion adjacent to said ring, said angled portion angling away from said exterior surface and toward said exterior surface of said ring; and
said angled portions proving an increase in contact surface area for said resilient band engaged thereon.
